(19) United States
(12) Patent Application Publication
(10) Pub. No.: US 2008/0236417 A1
(43) Pub. Date: Oct. 2, 2008

(54) Item Having Silicone Inserts Printed by Serigraphy and Process For Manufacturing Said Item

(75) Inventors: Marco Coffinardi, Bagnolo Mella Brescia (IT); Giulia Coffinardi, Bagnolo Mella Brescia (IT); Luciano Coffinardi, Bagnolo Mella Brescia (IT); Monica Coffinardi, Bagnolo Mella Brescia (IT)

Correspondence Address: SHOEMAKER AND MATTARE, LTD, 10 POST OFFICE ROAD - SUITE 110, SILVER SPRING, MD, 20910, US

(73) Assignee: GRUPPO DECORTEX S.R.L., Bagnolo Mella (Brescia) (IT)

(21) Appl. No.: 11/572,940

(22) PCT Filed: Jul. 30, 2004
(86) PCT No.: PCT/IT04/00428

§ 371 Date: Jan. 30, 2007

(51) Int. Cl. B05C 17/06; B41M 1/12

(52) U.S. Cl. 101/126; 101/129

(57) ABSTRACT

The invention concerns an item (4), comprising a tubular body (13), specifically a fabric item (4), specifically a stocking, a sock, tights, a knee-length sock, a glove and similar, having silicone inserts (2) printed by serigraphy and a process for printing silicone inserts (2) by serigraphy to produce said item (4).

### FIELD OF THE INVENTION

The subject of this invention is an item, comprising a tubular body, specifically a fabric item, specifically a stocking, a sock, tights, a knee-length sock, a glove and similar, having silicone inserts printed by serigraphy and a process for printing silicone inserts by serigraphy to manufacture said item.

### BACKGROUND OF THE INVENTION

The “frill” is a portion of fabric, sewn in a ring-shape, of varying heights, made from a material different from the material in which the “leg” is made; in fact the “frill” has very limited intrinsic elastic properties.

Further, on the “frill” one or more circular silicone strips are applied, for example by coating, according to the well known technique of “siliconising the frill”, which helps to carry out an anti-slip function for the stocking but which make the “frill” even more rigid.

It is therefore apparent that there is a need to offer a product which surpasses the limits of the known technique and a process for its manufacture which results in savings in terms of cost and time input.

### BRIEF DESCRIPTION OF THE DRAWINGS

The characteristics and advantages of this invention will in any case become apparent from the following description of a preferred embodiment, given by way of a non-limiting example, with reference to the attached drawings, in which:

FIG. 1 represents an overall view from above of a plant for carrying out a serigraphic printing process for silicone inserts;

FIG. 2 represents an overall view from above of an alternative form of creating a plant for carrying out a serigraphic printing process for silicone inserts;

FIG. 3 shows a perspective of an item manufactured according to a serigraphic printing process for silicone inserts;

FIG. 4 shows an enlarged detail of an item manufactured according to a serigraphic printing process for silicone inserts;

FIG. 5 shows a frontal view of part of a plant adapted to achieve a serigraphic printing process for silicone inserts;

FIG. 6 shows a side view of a further part of a plant for a serigraphic printing process for silicone inserts;

FIG. 7 shows a view from above of part of a serigraphic screen 14 adapted to achieve a serigraphic printing process for silicone inserts;

FIG. 8 shows a perspective of a shaped support 6 during a stage of a serigraphic printing process for silicone inserts.

FIG. 9 shows a side view of part of a plant for a serigraphic printing process for silicone inserts.

### DETAILED DESCRIPTION OF THE INVENTION

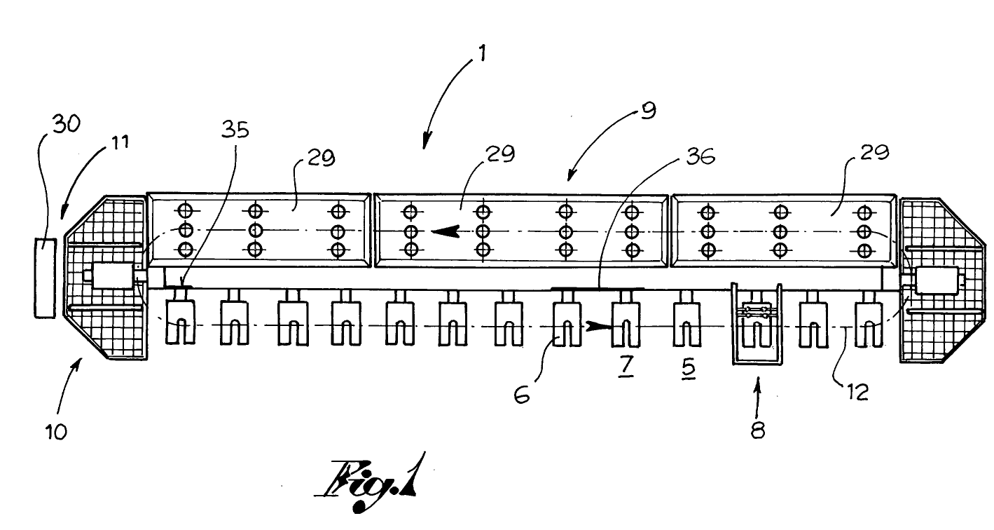

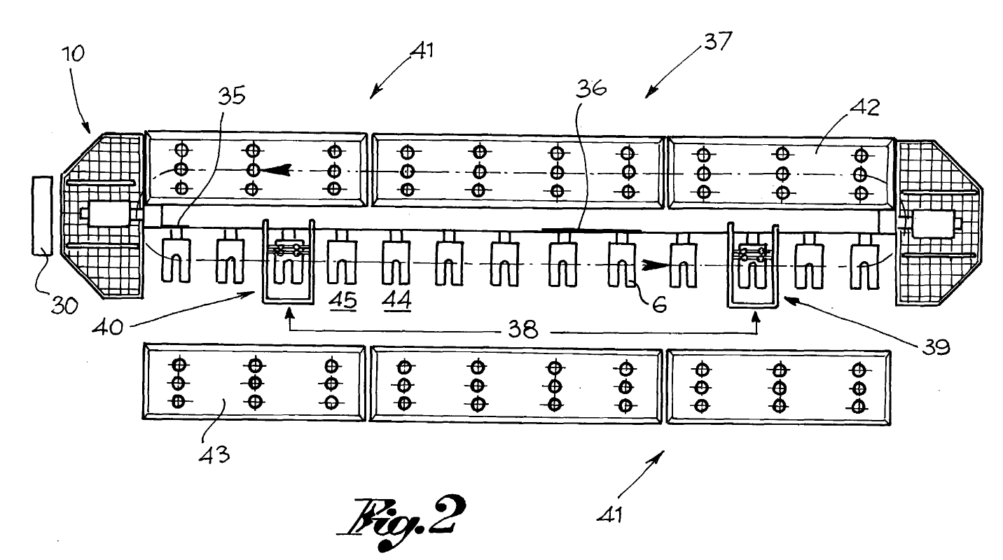

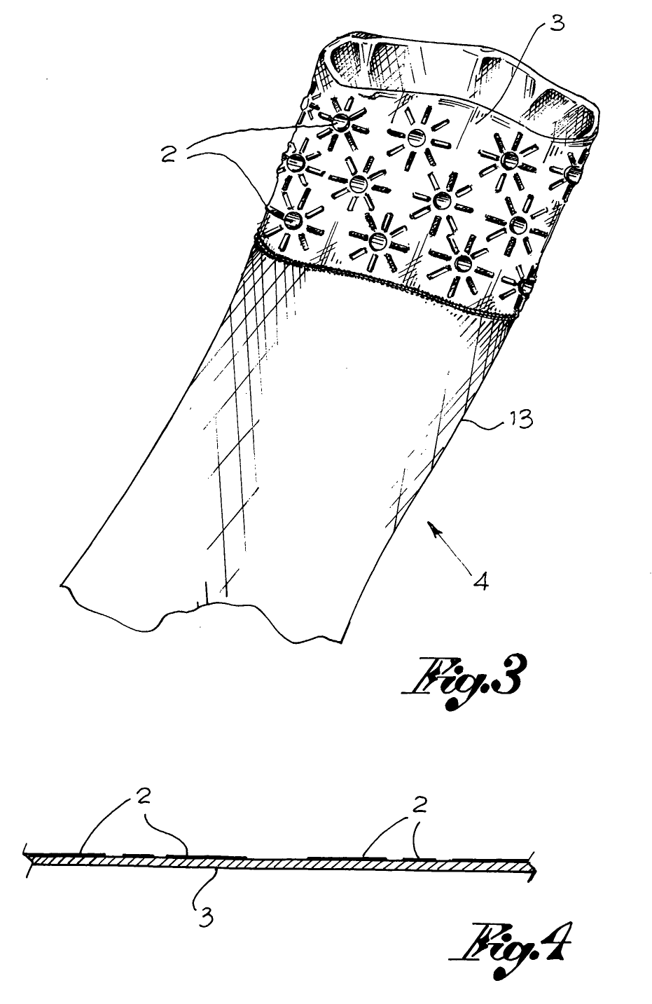

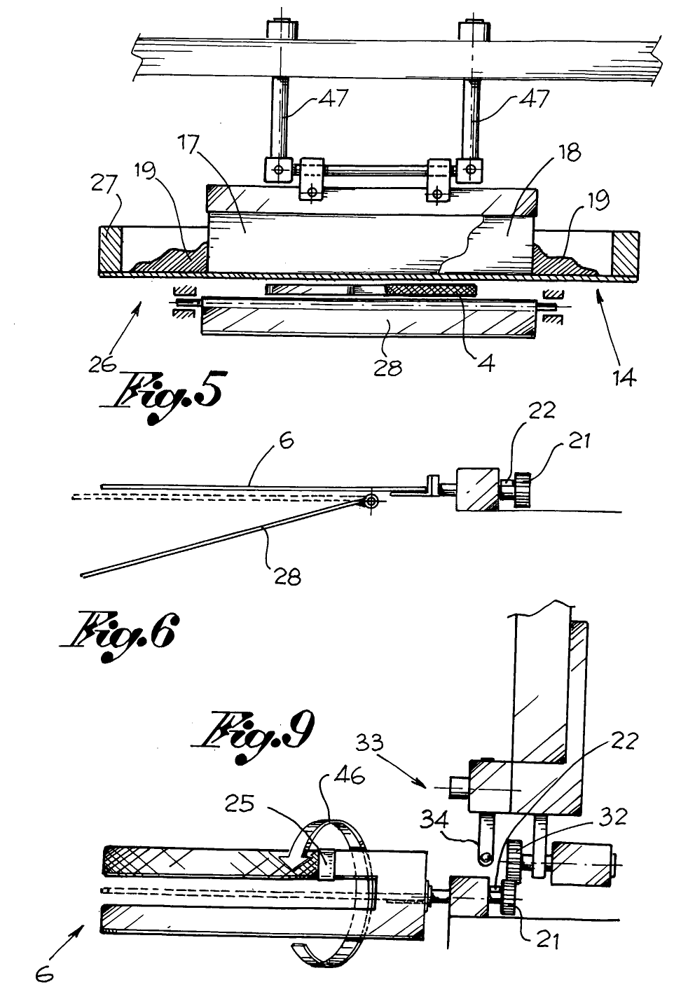

With reference to the attached drawings, and relating to one of the possible embodiments, in FIGS. 1 and 2, 1 indicates a plant to carry out a process to manufacture an item 4 such as an item in elastic material, such as a stocking, a self-supporting stocking, a sock, tights, a glove and similar, comprising a tubular body 13 comprising a friction surface 3 destined to come into contact with a resisting surface, such as the skin for example, said tubular body 13 having prints of silicone inserts carried out by serigraphy 2, said silicone inserts 2 being substantially arranged over a friction surface 3 of the item 4 and substantially protruding from said friction surface 3, to better hold said tubular body 13 to said resisting surface.

Said friction surface 3 is a portion of said item 4, for example a stocking, adapted to carry out an anti-slip function for the stocking along the wearing limb, supporting and maintaining the desired position for said stocking under normal use.

In a preferred embodiment, said tubular body 1 is a single one.

Favourably, said plant 1 includes at least one station for inserting 5 the item 4 onto a shaped support 6, otherwise known in technical jargon as a fitting station, at least one station for removing 7 the item 4 from the shaped support 6, at least one printing station 8, at least one drying station 9, at least one cooling station 11.

In a further embodiment of said plant 1 it favourably includes at least one station for rotation 10 of the shaped support 6.

In a preferred embodiment said plant 1 includes a closed circuit 12.

Advantageously said closed circuit 12 includes said printing station 8, said drying station 9, said cooling station 11, said station for rotation 10, said fitting station 5 and said station for removal 7.

In a preferred embodiment said serigraphic printing process for silicone inserts 2 on the surface of the item 4, specifically the fabric item 4 comprising said tubular body 13, specifically a stocking, a sock, tights, a glove and similar, includes the stage of preparing a serigraphic screen 14 (FIG. 5) adapted to carry out the serigraphic printing.

In a preferred embodiment of said serigraphic screen 14 it includes at least one flat surface 15 (FIG. 7).

Advantageously, said flat surface is a metal surface.

Favourably, said metal surface is a metal plate 15.

Advantageously said metal plate 15 is a plate 15 made from brass.

Favourably, said plate 15 is between 2 and 10 millimetres thick.

In a preferred embodiment, said plate is between 4 and 6 millimetres thick.

Favourably said plate is cut with through-holes designed to create an incision 16.

Said plate 15 advantageously bears at least one incision 16 designed to represent a decorative and/or aesthetic motif.

Favourably said decorative and/or aesthetic motif includes for example dots, lines, polygons, curved shapes and writing.

Further, there is at least one scraper 17 and at least one counter-scraper 18 designed to carry out serigraphic printing, said scraper 17 and said counter-scraper 18 are hinged on pins 47 connected to a support frame 27.

In a preferred embodiment said scraper 17 and said counter-scraper 18 are made from a metallic material, such as steel for example.

Advantageously said scraper 17 and said counter-scraper 18 are made from aluminium.

In a preferred method of execution, silicone 19 is prepared for the serigraphic print and subsequently said silicone 19 is poured onto the serigraphic screen 14.

Favourably the preparation of the silicone 19 for the serigraphic print includes the preparation of a mixture comprising at least one silicone rubber.

Favourably the silicone 19 includes a mixture of at least two elements.

In a preferred embodiment, said printing station 8 includes at least one mixing and pumping device (not shown in the drawing) designed to carry out said mixture of at least two elements.

Advantageously said mixture includes at least one silicone rubber and at least one hardening agent.

In a preferred embodiment said silicone 19 is bi-component silicone rubber.

A further stage of said process includes the preparation of the shaped support 6 with a form suitable to be fitted to said item 4.

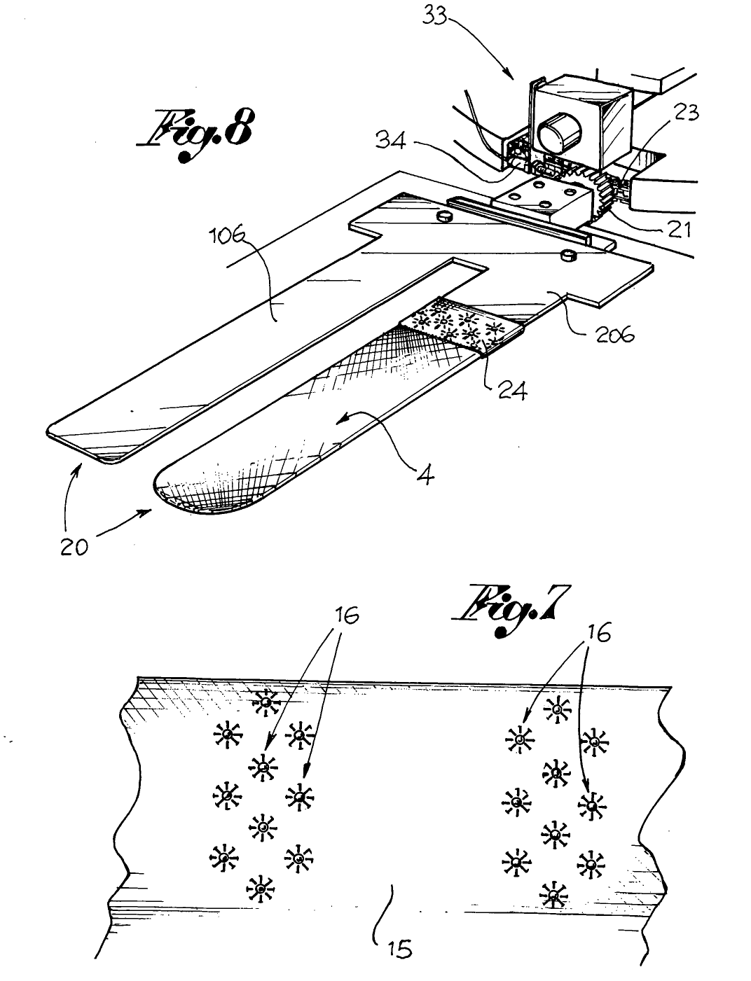

In a preferred embodiment said shaped support 6 includes a flat surface (FIG. 8).

Favourably said shaped support 6 includes at least two prongs 20.

Favourably said shaped support 6 is made from metallic material, such as steel or aluminium for example.

Advantageously said flat shaped support 6 includes at least two surfaces 106 and 206 designed to be covered by said item 4.

In a preferred embodiment said shaped support 6 includes a first cog wheel 21 fitted onto said shaped support 6.

In a preferred embodiment said shaped support 6 includes at least one cam 22 fitted onto said shaped support 6.

Favourably said shaped support 6 is connected by driving means (not shown in the drawing) suitable for moving said shaped support 6.

In a preferred embodiment said driving means include at least one transmission chain 23.

Favourably said driving means are controlled by automatic control means (not shown in the drawing).

Subsequently, starting from the fitting station 5, said item 4 is fitted onto said shaped support 6 so that said item 4 adheres to said shaped support 6.

In a preferred embodiment said item 4 is manually fitted onto said shaped support 6 by a trained operator.

Favourably the item 4 fitted onto the shaped support 6 displays an increased surface area equivalent to a value between 5% and 30% of the original dimensions of the item 4.

Advantageously said increase in surface area is equivalent to a value between 15% and 20% of the original dimensions of the item 4.

Further, the process according to this invention includes a preparation stage of at least one serigraphic printer 26 at said printing station 8 for the serigraphic printing of said silicone inserts 2.

In a preferred embodiment said serigraphic printer 26 includes the serigraphic screen 14.

Favourably said serigraphic printer 26 includes said support frame 27 adapted to accommodate said serigraphic screen 14.

Following said preparation stage for the serigraphic printer 26 the process according to this invention includes a positioning stage for said item 4 fitted onto said shaped support 6 below the serigraphic printer 26.

In a preferred embodiment, said serigraphic printer 26 includes a tilting plate 28 positioned below the serigraphic screen 14.

Advantageously said tilting plate 28 includes a stop designed to maintain the item 4 fitted onto the shaped support 6 in a position substantially adjacent to the serigraphic screen 14 during the serigraphic printing operation.

Favourably said serigraphic printer 26 includes actuation means (not shown in the drawing) designed to move said tilting plate 28 and said scraper 17 and said counter-scraper 18.

Favourably a serigraphic printing operation is carried out on said silicone inserts 2 on the surface of the item 4, via the silicone 19, using the scraper 17 and the counter-scraper 18.

In a preferred embodiment said serigraphic printing operation includes a stage of extending the scraper 17 and the counter-scraper 18 along the plate 15 of the serigraphic screen 14 designed to spread and work the silicone 19.

Favourably said extending stage is further intended to spread the silicone 19 on the plate 15 of the serigraphic screen 14, to allow transit of the silicone 19 through the incisions 16 and to deposit the silicone 19 on the surface of the item 4 below.

Subsequently said serigraphic printing operation includes a stage of printing by the scraper 17 and by the counter-scraper 18 along the plate 15 of the serigraphic screen 14, adapted to print the silicone 19 on the portion of the friction surface 3 of the item 4 fitted to the shaped support 6 and thus to create the silicone inserts 2 on said portion of the friction surface 3.

Favourably said extending stage and said printing stage are configured as a return sequence of operations of the scraper 17 and of the counter-scraper 18 along the plate 15 covered with silicone 19 of said serigraphic screen 14.

Favourably the item 4 fitted onto the shaped support 6 displays a first portion of friction surface 24 with a print, facing upwards, and a second portion of the friction surface 25, designed to be printed, facing downwards.

After the printing operation, the shaped support 6 is moved by said transmission chain 23 along the drying station 9 via which an initial drying operation is carried out.

In a preferred embodiment said initial drying operation includes warming of the item 4 fitted onto the shaped support 6 by at least one electric oven 29.

Favourably said electric oven 29 includes at least one drying lamp (not shown in the drawing).

In one embodiment, said initial drying operation has a timeframe of between twenty and two hundred seconds.

In a preferred embodiment said initial drying operation includes exposing the printed item 4 to the heating light of a single drying lamp.

Advantageously said initial drying operation includes the subsequent exposure of the printed item 4 to several drying lamps.

Favourably the initial drying operation includes exposing the printed item 4 to a sequence of several drying lamps, whose heating power gradually increases.

In a preferred embodiment the initial drying operation includes exposure of the printed item 4 to a sequence of lamps wherein the first drying lamp supplies a power equivalent to a value between 40% and 60% of the nominal power of said first lamp.

Advantageously the power supplied by the first drying lamp is equivalent to 50% of the nominal power of said first lamp.

In an alternative form of execution, the initial drying operation includes exposure of the printed item 4 to a sequence of lamps in which a second lamp supplies a power equivalent to a value of between 60% and 80% of the nominal power of said second lamp.

Advantageously the power supplied by the second drying lamp is equivalent to 70% of the nominal power of said second lamp.

In a further alternative form of execution, the initial drying operation includes the exposure of the printed item 4 to a sequence of lamps in which a third drying lamp supplies a power equivalent to a value of between 80% and 100% of the nominal power of said third lamp.

Advantageously the power supplied by the third drying lamp is equivalent to 90% of the nominal power of said third lamp.

Favourably the initial drying operation includes exposure of the printed item 4 to at least one drying lamp with a nominal power of at least 7 KW.

In a preferred form of execution, the initial drying operation includes exposure of the printed item 4 to a sequence of drying lamps with an overall nominal power of at least 21 KW.

In a preferred embodiment the drying station 9 includes at least one extractor hood (not shown in the diagram) designed to remove the fumes which may be emitted during said initial drying operation.

Further, the driving means take the shaped support 6 to the cooling station 11 wherein cooling of the printed item 4 takes place.

In a preferred form of execution the cooling is carried out by a fan 30.

Favourably cooling of the printed item 4 is designed to cool the printed silicone inserts 2 so that said printed silicone inserts 2 are not sticky and/or do not adhere to other surfaces, such as the hands of a trained operator for example.

Advantageously cooling of the printed item 4 is designed to provide a reduction in temperature of the printed item 4 of at least 2° C.

In a preferred embodiment the position of said cooling station 11 coincides with the position of the station for rotation 10.

Further, in an alternative form of execution, rotation of the shaped support 6 takes place at the same time as the cooling operation.

Favourably said automatic control means stop said transmission chain 23 via a stop signal when said shaped support 6 reaches said station for rotation 10.

Favourably said station for rotation 10 includes rotation means 31 designed to rotate said shaped support 6 (FIG. 9).

Advantageously said rotation means 31 are designed to carry out a rotation of one hundred and eighty hexagesimal degrees, for example in the direction of rotation indicated by the arrow 46 in FIG. 9.

Further, the rotation of the item 4 fitted onto the shaped support 6 is designed to turn the portion of printed friction surface 24 facing downwards.

In a preferred embodiment said rotation means 31 include at least a second cog 32.

Advantageously said second cog 32 is designed to achieve a fit with said first cog 21, fitted onto said shaped support 6, designed to transmit torque and therefore to carry out the rotation of one hundred and eighty hexagesimal degrees of the shaped support 6.

Favourably said station for rotation 10 includes further actuation means (not shown in the drawing) designed to provide a translating rotary motion to said second cog 32 to achieve a coupling with said first cog 21, on said shaped support 6.

In a preferred embodiment said station for rotation 10 includes rotation control means 33 designed to provide a signal that rotation has taken place to said automatic control means.

Favourably said rotation control means include a sensor 34.

In an alternative embodiment said sensor 34 is designed to read a portion of said fitted cam 22 and at the same time to provide said automatic control means with said signal that rotation has taken place.

Favourably said automatic control means are designed to synchronise said stop signal with a signal to control the serigraphic printing.

Favourably said automatic control means are designed to synchronise said signal that rotation has taken place with said signal for re-starting.

In a preferred embodiment, said synchronisation of said stop signal with said signal to control the serigraphic printing allows the rotation to be carried out in the same time interval in which the serigraphic printing is carried out.

Favourably during said rotation operation, simultaneous with said printing operation, the transmission chain 23 is stopped.

In a preferred embodiment said driving means include at least one stopping bar 35 designed to horizontally realign said shaped support 6 following rotation.

Favourably said driving means include at least one continuous bar 36 designed to horizontally align said shaped support 6.

In this way it is then possible to proceed, via the transmission chain 23, at the printing station 8 wherein the printing of the further portion of the friction surface designed to be printed 25 is carried out.

In an alternative embodiment, the transmission chain 23 then takes the shaped support 6 to the drying station 9 wherein a second drying operation of the printed silicone inserts 2 is carried out in a similar way to the first drying operation.

Subsequently a similar operation of cooling and rotation takes place.

Further at the station for removal 7 the item 4 is removed, having silicone inserts 2 printed by serigraphy, from the shaped support 6, for example manually by a trained operator.

In this way an item having silicone inserts 2 is obtained, printed by serigraphy on the friction surface 3 of an item 4; as can be seen in FIG. 4 said silicone inserts 2 are substantially arranged on said friction surface 3 and protrude from said friction surface 3.

Favourably said fitting station 5 and said station for removal 7 include at least one continuous bar 36 designed to horizontally realign said shaped supports following the manual operation of fitting and/or removal of the item 4 from the shaped support 6.

Advantageously said serigraphic screen 14 comprising the cut plate 15, for example in brass and allows excellent serigraphic printing of the silicone 19, supplying three dimensional definition of the most well-defined insert, with a more “rounded” aesthetic effect.

Surprisingly the optimal thickness of the cut plate 15 of between 4 mm and 6 mm provides a print of the silicone insert 2 which is shiny and free of pores.

Further said optimal thickness of the cut plate 15 allows silicone inserts 2 to be printed on a stocking with a thickness which optimises the anti-slip effect, at the same time said insert is substantially invisible from the outside, under normal conditions of use of the stocking.

Advantageously an item is obtained, such as a stocking, having silicone inserts 2 printed on said friction surface 3, designed to hold the item 4, for example a self-supporting stocking, onto the surface on which it is fitted, for example on the skin of the limb of a wearer.

Advantageously said silicone inserts 2 are substantially invisible under normal conditions of use of said stocking, in any case allowing excellent anti-slip action.

Further said stocking formed of a single body is dyed in a single dyeing operation, obtaining a dye of the self-supporting stocking with a uniform, homogeneous colour shade, and subsequently sent to the serigraphic printing plant for silicone inserts, allowing considerable time and cost savings.

Moreover said stocking is easily adapted to wearers of the same size but with different physical structures, by virtue of the substantially homogenous advanced elasticity of said stocking, therefore allowing easy wearing on two individuals of the same size but with different physical structures, and simultaneously avoiding circulatory problems and excessive pressure of the stocking on the covered limb.

Advantageously, in addition, certain types of wearers, for example pregnant women, finding it uncomfortable to use tights which are excessively tight around the waist and which are awkward to remove, or a self-supporting stocking, which similarly for example pinches around the wearing limb and inevitably slides against the skin, benefit from using a stocking produced as described, which does not slide against the skin and which does not pinch the waist excessively.

Further said optimal thickness of the plate 15 allows repeated washing operations of the silicone 19 after the printing cycle without the risk of said plate 15 being damaged by cracking or breaking during washing.

Advantageously the silicone 19 comprising the mixture of at least one silicone rubber and at least one hardening agent synergically contributes, with said cut plate 15, to clearly and attractively define the printed silicone insert 2.

Surprisingly the silicone 19 comprising said mixture of at least one silicone rubber and at least one hardening agent prevents, due to its viscosity, the silicone 19 from penetrating excessively into the fabric item 4, allowing printing of the silicone inserts 2 substantially on the surface of the item 4.

Advantageously said printing station 8 includes at least one mixing and pumping device designed to create said mixture of at least one silicone rubber and at least one hardening agent.

Advantageously said mixture of at least one silicone rubber and at least one hardening agent also prevents excessive intake of air during creation of said mixture.

Advantageously said scraper 17 and said counter-scraper 18 are made from a metallic material which does not deteriorate during the long printing cycles which involve continuous friction of said scraper 17 and said counter-scraper 18 on the surface of said brass plate 15.

Unusually, via said serigraphic printing process for silicone inserts 2, costs in terms of time, human resources and raw materials are drastically reduced; in fact the producer only needs to provide the printer with the stocking in the desired size and subsequently the silicone inserts 2 are printed on said stocking, avoiding the intermediate stages of production of the “frill” in a different fabric from the “leg”, siliconising the “frill”, preparation of the desired size of the “frill”, dyeing of the “frill”, sewing of the “frill” to give it a circular shape and finally sewing of the “frill” onto the “leg”.

Advantageously, in addition the serigraphic printing includes the printing of silicone inserts 2 reproducing a very wide range of decorative and/or aesthetic motifs, therefore allowing complete customisation and possibly full identification of the product with the manufacturer's trademark.

Advantageously it is possible to use silicone 19 comprising coloured pigments and therefore to achieve coloured decorative and/or aesthetic motifs and writing.

Alternatively transparent silicone 19 is used, which therefore gradually takes on the shade of the stocking.

Advantageously the stocking manufacturer supplies a stocking with one end folded over and sewn on a portion of stocking which is superimposed, thus forming the friction surface 3; in this way a stocking to be printed is provided with a reinforced end and designed to accommodate the silicone inserts 2 printed by serigraphy, without detracting from the stocking's elastic properties.

Surprisingly the printing of discontinuous silicone inserts 2, for example dots, segments, decorative motifs and the elasticity of the material from which the stocking is made, bestow an unusual combined effect of increased elasticity and anti-slip effect of the stocking.

Advantageously said stocking maintains its relative position in relation to the wearing surface, avoiding for example continuous manual adjustments of the stocking's position.

Unlike the well-known self-supporting stocking which, for each size established, requires production of a “frill” of a length designed to couple with a “leg”, to create the self-supporting stocking in the desired size, and in which the “frill” thus produced is sewn to an end of the “leg”, with a great input of time and cost resources, to allow coupling between the two portions and forming the final self-supporting stocking, so that the silicone strips remain inside the tubular body 13 during normal conditions of use of the stocking, the stocking proposed here is made in a single piece, favourably having silicone inserts 2, within said tubular body 13 under normal conditions of use of said stocking, designed to hold said stocking on the surface of the wearing limb.

Further it is advantageous to fit said item 4 onto the shaped support 6 to give an extended surface area of said item 4 of 15-20% and to obtain optimal adhesion to shaped support 6: this results in better printing free from wrinkles.

Surprisingly, in addition, when the item 4 is removed and relaxes, it tends to take the printed insert further into the surface, increasing the aesthetic effect and anti-slip action.

Advantageously, via the drying station 9 as described, drying and/or desiccation of the printed silicone inserts 2 is obtained, which is homogeneous and gradual.

Advantageously in this way the formation of a hard crust of silicone 19 on the surface is prevented, which holds any air bubbles forming from the centre of the silicone insert 19 as soon as it is printed and damages the internal and superficial structure of the silicone insert 2.

Surprisingly, during drying, the item 4 fitted onto the shaped support 6 heats up, both starting from above, from the external surface in contact with the hot air of the electric oven 29, and from below, from the surface in contact with the stocking and indirectly with the hot metal shaped support 6, by effect of thermal conduction.

Further said thermal conduction effect from below contributes to gradual, homogeneous heating of the silicone insert 2, supplying a finished product free from bubbles, creases and/or cracks.

Advantageously said mixing and pumping device operates in absence of air, therefore allowing a mixture which minimises the englobing of air and the formation of any air bubbles.

Advantageously the power supplied by the electric oven 29 may be adjusted according to the surface and thickness of the printed silicone insert to be dried.

Advantageously the station for rotation 10 allows for rotation of the item 4 fitted onto the shaped support 6 to prepare it for printing on the portion of friction surface 3 which has not yet been printed; this rotation avoids removing the item 4 from the shaped support 6 and re-fitting it with the surface to be printed facing upwards, allowing a rigorous, symmetrical alignment of the resulting decorative and/or aesthetic motif to be maintained.

Advantageously rotation of the fitted item 4 allows reduction of labour costs and considerable time savings for production.

A variation of production for a plant (FIG. 2) to achieve the serigraphic printing process of silicone inserts 2 will now be presented.

Said variation includes a plant 37 comprising a printing station 38.

Said printing station 38 includes at least a first printer 39 connected to a second printer 40 and a fitting station 44.

Favourably said plant 37 also includes a drying station 41 comprising at least a first electric drying oven 42 parallel with a second electric drying oven 43.

Advantageously it is possible to carry out an initial serigraphic print on the first printer 39 on one side of the item 4 and to proceed to the initial drying operation in the first electric oven 42.

The operations of cooling and rotation are then carried out.

The transmission chain 23 then takes the item 4, fitted onto the shaped support 6, to the printing station 38 wherein a second serigraphic print takes place on the second printer 40.

Favourably at the station for removal 45 the item 4 is removed from the shaped support 6 and manually deposited in a second electric oven 43 to carry out a second drying operation.

Favourably the speed of movement of said transmission chain 23 allows said removal to be carried out manually by the trained operator, and simultaneously, at the fitting station 44, to fit onto said shaped support 6, from which said printed item 4 has been removed, a further item 4 to be sent to the first serigraphic print at the first printer 39. Advantageously said plant 37 allows time and cost resources required for the industrial production of an item 4 printed according to the process described, to be reduced considerably.

1-95. (canceled)

96. Item (4) such as an item in elastic material, such as a stocking, a self-supporting stocking, a sock, tights, a glove and similar, comprising a tubular body (13) comprising a friction surface (3) designed to be brought into contact with a resisting surface, said tubular body (13) having silicone inserts protruding from said friction surface (3) to better hold said tubular body (13) to said resisting surface, characterised in that said silicon inserts are obtained by fitting said item (4) onto a shaped support (6) so that said item (4) adheres to said shaped support (6), positioning said item (4) fitted onto said shaped support (6) below and adjacent a metal plate (15) in which at least a through-hole incision (16) representing the shape of the insert to be printed is provided, pouring a silicone mixture (19) comprising at least a silicone rubber onto said metal plate (15), and spreading said silicone mixture (19) on the metal plate (15) in such a way to allow the transit of the mixture through said incision (16) and the deposit of the mixture on the surface of the item.

97. Item according to claim 96, wherein said silicone inserts (2) are positioned inside said tubular body (13) under normal conditions of use of the item.

98. Item according to claim 96, wherein said tubular body (1) is in a single piece.

99. Item according to claim 96, wherein the silicone inserts (2) include silicone (19) comprising a mixture of at least one hardening agent and at least one silicone rubber.

100. Item according to claim 99, wherein the silicone (19) includes a liquid bi-component silicone rubber.

101. Process for printing silicone inserts (2) on the surface of an item (4), such as an item in elastic material, such as a stocking, a self-supporting stocking, a sock, tights, a glove and similar, comprising the steps of:
providing a metal plate (15) with at least a through-hole incision (16) representing the shape of the insert to be printed;
preparing a mixture (19) comprising at least a silicone rubber;
providing a shaped support (6) of a shape adapted to be fitted by said item (4);
fitting said item (4) onto said shaped support (6) so that said item (4) adheres to said shaped support (6);
positioning said item (4) fitted onto said shaped support (6) below and adjacent the metal plate (15);
pouring the silicone mixture (19) onto said metal plate (15);
spreading said silicone mixture (19) on the metal plate (15) in such a way to allow the transit of the mixture through said incision (16) and the deposit of the mixture on the surface of the item below; and
carrying out an initial drying operation of the printed silicone inserts (2).

102. Process according to claim 101, comprising the steps of:
carrying out rotation of the shaped support (6);
carrying out the printing of the silicone inserts (2) on a further portion of the friction surface (3) of the item (4);
carrying out a second drying operation of the printed silicone inserts (2).

103. Process according to claim 101, wherein said step of spreading said silicone mixture (19) on the metal plate (15) includes the step of extending the mixture silicone (19) with a scraper (17) and a counter-scraper (18) along said plate (15).

104. Process according to claim 101, wherein said drying operation includes the stage of heating the item (4) fitted onto the shaped support (6) by at least one electric oven (29).

105. Process according to claim 101, wherein said drying operation includes the stage of exposing the printed item (4) to the light of at least one drying lamp.

106. Process according to claim 105, wherein the drying operation includes the stage of exposing the printed item (4) to a sequence of several drying lamps with gradually increasing heating power.

107. Process according to claim 106, wherein the drying operation includes the stage of exposing the printed item (4) to a sequence of lamps wherein the first drying lamp supplies a power equivalent to a value of between 40% and 60% of the nominal power of the first lamp.

108. Process according to claim 107, wherein the drying operation the stage of exposing the printed item (4) to a sequence of lamps wherein a second lamp supplies a power equivalent to a value of between 60% and 80% of the nominal power of the second lamp.

109. Process according to claim 108, wherein the drying operation includes the stage of exposing the printed item (4) to a sequence of lamps wherein a third drying lamp supplies a power equivalent to a value of between 80% and 100% of the nominal power of the third lamp.

110. Process according to claim 101, comprising a stage of cooling the printed item (4).

111. Process according to claim 110, wherein the stage of cooling the printed item (4) includes cooling the printed silicone inserts (2) so that said silicone inserts (2) are not sticky and/or adhesive.

112. Plant for printing silicone inserts (2) on the surface of an item (4), such as an item in elastic material, such as a stocking, a self-supporting stocking, a sock, tights, a glove and similar, according to the process of claim 99, comprising:
at least one printing station (8);
at least one drying station (9);
at least one cooling station (11);
at least one station for inserting (5) an item (4) onto a shaped support (6);
one station for removal (7) of said item (4) from said shaped support (6);
driving means (23) adapted to move said shaped support (6) along said printing station (8), said drying station (9), said cooling station (11), said fitting station (5) and said station for removal (7), wherein said printing station comprises a metal plate (15) in which at least a through-hole incision (16) representing the shape of the insert to be printed is provided, and a scraper (17) and a counter-scraper for spreading a silicone mixture (19) on the metal plate (15) in such a way to allow the transit of the mixture through said incision (16) and the deposit of the mixture on the surface of the item below.

113. Plant according to claim 112, comprising:
at least one station for rotation (10) for a shaped support (6);
driving means adapted to move said shaped support (6) along said station for rotation (10).

114. Plant according to claim 112, wherein said printing station includes a tilting plate (28) adapted to keep the item (4) fitted onto the shaped support (6) in a position substantially adjacent to the metal plate during the operation of printing.

115. Plant according to claim 112, wherein said metal plate is between 4 and 6 millimetres thick.

116. Plant according to claim from 112, wherein said through-hole incision includes decorative and/or aesthetic motif, dots, lines, polygons, curved shapes and writing.

117. Plant according to claim 112, wherein said scraper (17) and said counter-scraper (18) are made from steel.

118. Plant according to claim 112, wherein said driving means (23) include at least one transmission chain adapted to move the shaped support (6) along a closed circuit (12) comprising the printing station (8), the drying station (9), the cooling station (11), the station for rotation (10), the fitting station (5) and the station for removal (7).

119. Plant according to claim 118, wherein said driving means include at least one stopping bar (35) adapted to horizontally align said shaped support (6).

120. Plant according to claim 113, wherein said station for rotation is adapted to carry out rotation of said shaped support (6) of one hundred and eighty hexagesimal degrees.

121. Plant according to claim 112, wherein said printing station (8) includes at least one device for mixing and pumping adapted to create the mixture of at least two elements of the silicone inserts.

122. Plant according to claim 121, wherein said device for mixing and pumping operates in absence of air.
